(19) United States
(12) Patent Application Publication
(10) Pub. No.: US 2026/0121396 A1
(43) Pub. Date: Apr. 30, 2026

(54) DETECTION OF SECONDARY ARC EXTINCTION AND OPTIMIZING AUTO RECLOSING ON A TRANSMISSION LINE

(71) Applicant: Hitachi Energy Ltd, Zürich (CH)

(72) Inventors: Michael Stanek, Gebenstorf (CH); Urmil Parikh, Ludvika (SE); Mehulbhai Ghanshyambhai Sonagra, Gujarat (IN); Umamahesh Pasumarthi, Bangalore (IN); Abinash Sahoo, Bengaluru (IN)

(21) Appl. No.: 19/473,193

(22) PCT Filed: May 24, 2023
(86) PCT No.: PCT/EP2023/063985

§ 371 Date: Oct. 7, 2025

(30) Foreign Application Priority Data
Apr. 7, 2023 (IN) 202311026254

(51) Int. Cl. H02H 3/06; H02H 1/00; H02H 3/00; H02H 3/46

(52) U.S. Cl. CPC H02H 3/066; H02H 1/0015; H02H 3/006; H02H 3/46

(57) ABSTRACT

Detection of secondary arc extinction and optimizing auto reclosing on the transmission line is described. The method includes detecting isolation of at least one phase of a transmission line connected between a first circuit breaker and a second circuit breaker, detecting extinction of a secondary arc on the transmission line, collecting a plurality of samples for a pre-determined time period following extinction of the secondary arc, analyzing the plurality of samples to identify parameters descriptive of a first waveform, extrapolating a second voltage waveform across the first circuit breaker based on the identified parameters, determining a plurality of potential target auto-reclosure points based on the extrapolated second voltage waveform across the first circuit breaker, dynamically selecting a target auto-reclosure instant from the plurality of potential target auto-reclosure points, and controlling auto-reclosure of the first circuit breaker based on the dynamically selected target auto-reclosure instant.

### CROSS REFERENCE TO RELATED APPLICATIONS

This application is a 35 U.S.C. § 371 national stage application of PCT International Application No. PCT/EP2023/063985 filed on May 24, 2023, which in turn claims priority to Indian Patent Application No. 202311026254, filed on Apr. 7, 2023, the disclosures and content of which are incorporated by reference herein in their entireties.

### TECHNICAL FIELD

The present invention relates, in general, to controlled switching of circuit breakers. In particular, the present invention relates to detection of secondary arc extinction and optimizing auto-reclosing on a transmission line.

### BACKGROUND

In the present power system scenario, most of the faults that occur on high voltage transmission lines are single line to ground (SLG) faults and are primarily transitory in nature. A power transfer limit during a SLG fault determines the transmission capability rating of a line, provided such faults could be cleared, and the line can be successfully reclosed. Generally, techniques such as three-pole auto-reclosing (TPAR) and single-pole auto-reclosing (SPAR) are employed for clearing transitory SLG faults.

Typically, a fault occurring on a transmission line is detected by protection relays based on signals received from current transformers and voltage transformers. Generally, on detection of a fault, the protection relays will trip the circuit breakers (CBs) provided at both ends on the transmission line, and the faulty phases of the transmission line are isolated within a short period of time. Most line faults occur through a flashover from line to ground, and in such occurrences, the transmission line is generally disconnected from all sources through circuit breakers to clear the faults. Also, following the disconnection, auto-reclosing (AR) of the circuit breakers is often employed to restore the transmission line's operation at the earliest. The time period between the disconnection or trip and the auto-reclosing is generally referred to as auto-reclosing dead time.

### SUMMARY

Embodiments of the present invention provide techniques for detection of secondary arc extinction and optimizing auto-reclosing on a transmission line. In one example, techniques for detection of secondary arc extinction are provided. In another embodiment, techniques for optimizing auto-reclosing on a transmission line are discussed based on detection of secondary arc extinction. Objectives of embodiments of the present invention include accurate determination of potential target points for auto-reclosing on the transmission line in order to minimize a risk of high switching overvoltages that may be introduced during reclosure and minimizing the amount of time required to initiate the auto-reclosing on the transmission line.

According to a first aspect, a method for controlled auto-reclosure is described. The method includes detecting isolation of at least one phase of a transmission line connected between a first circuit breaker and a second circuit breaker, detecting extinction of a secondary arc on the transmission line, collecting a plurality of samples for a pre-determined time period following extinction of the secondary arc, analyzing the plurality of samples to identify parameters descriptive of a first waveform, extrapolating a second voltage waveform across the first circuit breaker based on the identified parameters, determining a plurality of potential target auto-reclosure points based on the extrapolated second voltage waveform across the first circuit breaker, dynamically selecting a target auto-reclosure instant from the plurality of potential target auto-reclosure points, and controlling auto-reclosure of the first circuit breaker based on the dynamically selected target auto-reclosure instant.

According to a second aspect, a controlled switching device is provided. The controlled switching device includes a detection module, an analyzing module, and a control module. The detection module is to detect isolation of at least one phase of a transmission line connected between a first circuit breaker and a second circuit breaker and to detect extinction of a secondary arc on the transmission line. The analyzing module is to collect a plurality of samples for a pre-determined time period following extinction of the secondary arc, analyze the plurality of samples to identify parameters descriptive of a first waveform, extrapolate a second voltage waveform across the first circuit breaker based on the identified parameters, determine a plurality of potential target auto-reclosure points based on the extrapolated second voltage waveform across the first circuit breaker, and dynamically select a target auto-reclosure instant from the plurality of potential target auto-reclosure points. The control module is to control auto-reclosure of the first circuit breaker based on the dynamically selected target auto-reclosure instant.

According to a third aspect, a non-transitory computer readable medium containing program instructions that, when executed, causes the processor to perform the method for controlled auto-reclosure on the transmission line, is provided.

According to an implementation of the present invention, the first waveform is any one of a gap voltage waveform across the first circuit breaker, a transmission line voltage waveform, or a current waveform through a shunt reactor connected to the transmission line. The secondary arc extinction is detected by acquiring at least one signal corresponding to the first waveform in the at least one phase of the transmission line, identifying a fundamental frequency component and a harmonic frequency component of the at least one signal corresponding to the first waveform in the at least one phase of the transmission line, and analyzing the fundamental frequency component and the harmonic frequency component to satisfy a pre-determined criterion, where the pre-determined criterion includes at least one of the fundamental frequency component being above a fundamental frequency threshold and the harmonic frequency component being below a harmonic frequency threshold.

According to an implementation, the secondary arc extinction is detected by monitoring the fundamental frequency component and the harmonic frequency component to satisfy the pre-determined criterion for a preset amount of time. The plurality of potential target auto-reclosure points are determined based on zero crossings of the extrapolated second voltage waveform across the first circuit breaker.

According to an implementation, the target auto-reclosure instant is dynamically selected from the plurality of potential target auto-reclosure points based on properties of the first circuit breaker and of the potential target auto-reclosure points.

According to an implementation, the auto-reclosure of the first circuit breaker is initiated before a set dead time of the first circuit breaker.

According to an implementation, the pre-determined time period is dynamically varied based on any one of a pre-determined number of samples, parameters of the transmission line, method of signal analysis, or on a status of switchgear or of control and protection devices in a substation to which the transmission line is connected.

### BRIEF DESCRIPTION OF DRAWINGS

The features, aspects, and advantages of the present invention will be better understood with regard to the following description and accompanying figures. The use of the same reference number in different figures indicates similar or identical features and components.

FIG. 1 illustrates a schematic arrangement of an electrical network including a controlled switching device for controlled auto-reclosure on a transmission line, in accordance with an embodiment of the present invention.

FIG. 2(a) illustrates a block diagram of a controlled switching device, in accordance with an embodiment of the present invention.

FIG. 2(b) illustrates a graph depicting a transmission line voltage waveform, in accordance with an embodiment of the present invention.

FIG. 2(c) illustrates a graph depicting a fundamental frequency component and a harmonic frequency component, in accordance with an embodiment of the present invention.

FIG. 3(a) illustrates a timing diagram of a trip and an auto-reclose event, considering a circuit breaker at one end of the transmission line, based on techniques known in the art.

FIG. 3(b) illustrates a timing diagram of a trip and an auto-reclose event, considering a circuit breaker at one end of the transmission line, in accordance with an embodiment of the present invention.

FIG. 4(a) illustrates an example controlled auto-reclosing on a transmission line, in accordance with an embodiment of the present invention.

FIG. 4(b) illustrates an example controlled auto-reclosing on a transmission line with shortened auto-reclosure time of a circuit breaker, in accordance with an embodiment of the present invention.

FIG. 5 illustrates a method for controlled auto-reclosure on a transmission line, in accordance with an embodiment of the present invention.

### DETAILED DESCRIPTION

The present invention relates to controlled auto-reclosures on a transmission line. The following description describes techniques of determining optimum target points and dead time for auto-reclosure on a transmission line based on detection of secondary arc extinction when an isolation of the transmission line is detected, on occurrence of a fault.

Typically, when a faulty phase of the transmission line is isolated by single pole switching, the faulty phase remains coupled to the energized phases, by electrostatic and electromagnetic coupling. For example, when the transmission line is a three-phase transmission line, the transmission line includes three conductors, one conductor corresponding to each phase of the three phases of the transmission line. The three phases of the transmission line may be referred to as R-phase, Y-phase, and B-phase. If a single line to ground fault occurs, for example, in the R-phase of the transmission line, the conductor of the R-phase, or the faulty phase, would be isolated, while the conductors of the other phases such as the Y-phase and the B-phase would remain energized. Due to the mutual inductance between the conductors of an energized phase and an isolated phase, voltage and current may be induced in the isolated phase. As a result of this, a residual or secondary arc current continues to flow in a fault arc path, a path through which the fault current flows, generally established between a phase conductor and ground.

Attempting an auto-reclosing while the fault may still be present results in flow of high fault currents, which could in turn result in stressing the equipment and the power system. Hence, in order to ensure successful auto-reclosure, an attempt for reclosure shall preferably be made only after the secondary arc is quenched or extinguished.

When a circuit breaker is closed to energize a no-load transmission line, a transmission line which generally has no load coupled to it, current generally starts flowing before the mechanical contacts of a circuit breaker touch, due to electrical arcing in the circuit breaker poles. This is called pre-strike; it occurs when the voltage across the contacts of circuit breaker exceeds the instantaneous dielectric strength of the gap between approaching contacts. The pre-strike voltage is the voltage across the circuit breaker at the instant of current inception; its amplitude is directly related to the magnitude of the source voltage, voltage measured at the voltage source, and of a residual voltage, such as a DC voltage or an oscillating voltage, on the transmission line. The propagation of this pre-strike voltage via electromagnetic waves along the transmission line, generally referred to as traveling wave phenomena, can cause undesirable overvoltages on the line. Therefore, measures for overvoltage protection and/or mitigation are required to limit the switching overvoltages. Typically, methods such as line surge arrestors, pre-insertion resistor (PIR), and controlled switching device (CSD) are used to mitigate switching overvoltages.

For unloaded transmission lines-controlled energization is used to minimize the switching overvoltage on the line. Controlled energization refers to energization or restoring of the transmission line by ideally energizing each phase of the transmission line in the proximity of voltage zero across the corresponding circuit breaker pole, where each pole of the circuit breaker may be associated with a phase of the transmission line. In one example, controlled energization may be used to minimize the switching overvoltage on the line during dead-line charging as well as during re-energization as part of an auto-reclosure sequence. Where dead-line charging refers to the initial energization of a transmission line or re-energization of the transmission line after dissipation of essentially all residual voltage on the line. Isolating a transmission line will leave a residual voltage in each phase of the transmission line, which will eventually decay to zero. In many cases, the decay time of the residual voltage is far longer than the auto-reclosure dead time. Hence, for controlled auto-reclosing, the controlled switching device (CSD) needs to consider any residual voltage remaining on the line from the preceding trip.

In a known technique, voltage samples from both ends of the circuit breaker, a source side, and a line side, may be obtained, and subtracted to determine a gap voltage, and then different properties of waveform are analyzed in order to predict the gap voltage waveform for controlled switching application.

In another known technique, samples for predicting a waveform to find a zero crossing of a gap voltage, are taken after a fixed time delay from the circuit breaker being opened. Samples from the line voltage waveform are collected after the fixed time delay and extrapolated to predict the gap voltage waveform. The starting instant for collecting these samples, may be before the secondary arc is quenched. Therefore, the sample window may contain some secondary arc voltage as well. The presence of secondary arc causes the voltage on the transmission line to be suppressed and has an irregular wave shape that makes it rich in harmonic content. The predicted gap voltage extrapolated from samples that include secondary arc voltage may therefore not accurately reflect the actual gap voltage around the auto-reclosure instant. Controlled switching of the transmission line performed based on the waveform predicted from extrapolating samples collected in the presence of secondary arc can therefore result in higher switching overvoltages. This overvoltage may be caused due to a mismatch in a zero crossing of the predicted gap voltage waveform and the zero crossing of an actual gap voltage waveform.

Further, a set auto-reclosure dead time, which is the time period between initiating the circuit breaker to trip and initiating an auto-reclosure on the transmission line, is often a compromise between quick restoration to service, system stability, and minimizing the likelihood of reclosing onto a fault that may be still present on the line. Longer auto-reclosure dead time decreases the power quality to the consumers and also increases the risk of system instability. Therefore, shorter auto-reclosure dead times can be preferred. However, reducing the auto-reclosure times without detecting whether the fault is actually extinguished could increase the risk of reclosing onto a fault, which would aggravate the problems with power quality and system stability. Thus, a set auto-reclosure dead time may create an unnecessarily long waiting time between fault clearing and circuit breaker reclosing.

The present invention addresses these and other problems of conventional techniques for controlled auto-reclosure on the transmission line. The present invention provides a method and a controlled switching device to accurately predict zero crossings of a gap voltage waveform across a circuit breaker pole by detecting an extinction of the secondary arc and collecting samples to extrapolate a voltage waveform after the secondary arc is quenched. Additionally, the present invention provides techniques to dynamically minimize the auto-reclosure dead time based on detection of secondary arc extinction on the transmission line. In one example, auto-reclosing may be initiated as soon as the secondary arc extinction has been detected in all phases that had been tripped due to the fault.

In operation, isolation of at least one phase of a transmission line connected between a first circuit breaker and a second circuit breaker is detected, an extinction of a secondary arc on the transmission line is detected, a plurality of samples for a pre-determined time period following the extinction of the secondary arc are collected, the plurality of samples are analysed to identify parameters descriptive of a first waveform. Based on the identified parameters, a second voltage waveform across the first circuit breaker is extrapolated. Further, based on the extrapolated second voltage waveform across the first circuit breaker, a plurality of potential target auto-reclosure points are determined, from which a target auto-reclosure instant is dynamically selected. Finally, auto-reclosure of the first circuit breaker is controlled such that current inception occurs at the dynamically selected target auto-reclosure instant. In one example, the auto-reclosure of the first circuit breaker is initiated before a set dead time of the first circuit breaker based on detection of the secondary arc extinction.

Therefore, to accurately predict a gap voltage waveform which replicates the actual voltage waveform across the circuit breaker, techniques of the present invention detect secondary arc extinction to control collecting of voltage samples for waveform prediction, thereby ensuring successful auto-reclosure and minimizing high switching overvoltages. Additionally, techniques of the present invention dynamically minimize the auto-reclosure dead time based on detection of the secondary arc extinction on the transmission line, thereby resulting in quick restoration to service while maintaining system stability and minimizing the likelihood of reclosing onto a fault.

The above and other features, aspects, and advantages of the invention will be better explained with regard to the following description and accompanying figures. Wherever possible, the same reference numbers are used in the drawings and the following description to refer to the same or similar parts. While several examples are described, modifications, adaptations, and other implementations are possible.

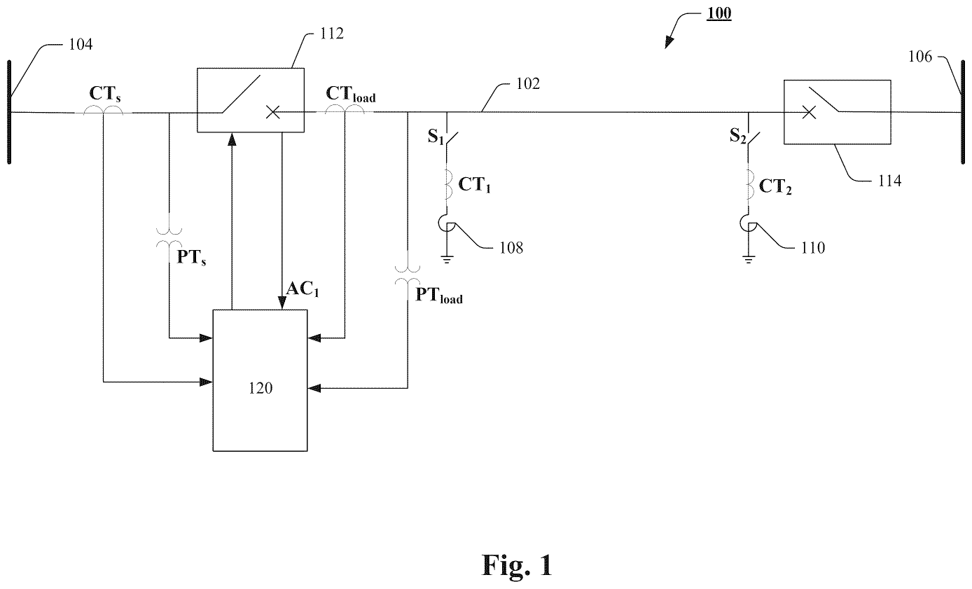

FIG. 1 illustrates a schematic arrangement of an electrical network 100 including a controlled switching device for controlled auto-reclosure on a transmission line, in accordance with an embodiment of the present invention. An electrical network 100 comprises a transmission line 102, alternatively referred to as line 102, connected between bus bar 104 and bus bar 106. In one example, a generator (not shown in the figure) may supply power to the bus bar 104, alternatively referred to as a local bus bar 104. Power supplied by the generator, is further supplied via the transmission line 102 to a receiving substation, represented by the bus bar 106, alternatively referred to as a remote busbar 106. Further, the electrical network 100 includes a plurality of shunt reactors, such as shunt reactor 108 and shunt reactor 110 connected on the transmission line 102 to compensate line charging current. In one example, the transmission line 102 may be connected to bus bar 104 by a first circuit breaker 112, alternatively referred to as a local circuit breaker 112, and connected to bus bar 106 by a second circuit breaker 114, alternatively referred to as a remote circuit breaker 114, at the ends of the transmission line 102, respectively. In one example, the first circuit breaker 112 and the second circuit breaker 114 may be provided to isolate the transmission line 102 from bus bar 104 and bus bar 106, respectively.

It will be understood that the electrical network 100 may include a plurality of additional components or devices for monitoring, sensing, and controlling various parameters that may be associated with the network but are not shown for brevity. For example, components such as protection relays, sensors, current transformers, voltage transformers, loads coupled to the transmission lines, shunt reactors, surge arresters, intelligent electronic devices IEDs, and the like may be coupled to the network. In one example, a controlled switching device 120 that may be configured to perform controlled auto-reclosure on the transmission line 102 may be coupled to the electrical network 100.

According to an example implementation of the present invention, the controlled switching device 120 may receive voltage and current measurements associated with the transmission line 102. In one example, the controlled switching device 120 may be configured to receive input measurement signals from various measurement equipment coupled to the electrical network 100, such as current transformers, potential transformers, Rogowski coils, capacitive dividers, optical sensors, or other measurement sensors. In one example, a current transformer CTₛ may be coupled to the controlled switching device 120 to monitor current passing through the first circuit breaker 112, and an auxiliary contact AC₁ may be used to obtain the breaker status information. In one example, the controlled switching device 120 may be configured to obtain source side measurements, such as a source voltage, a source current, and the like, from a point connected between the bus bar 104 and a first terminal of the first circuit breaker 112. In one example, the source voltage may be obtained from a source side potential transformer PTₛ and the source current may be measured from the current transformer CTₛ. Similarly, the controlled switching device 120 may be configured to obtain load side measurements, such as a load voltage, a load current, and the like, between the terminal of the first circuit breaker 112 connected to the transmission line 102 and the second circuit breaker 114. In one example, a load voltage measurement may be obtained from a potential transformer PT_{load} and the load current may be measured from the current transformer CT_{load}. In one example, the load voltage measurement may be a transmission line voltage measurement and the load current measurement may be a transmission line current measurement.

In one example, the controlled switching device 120 may be an electronic device, in particular an intelligent electronic device (IED). In another example, the controlled switching device 120 may be part of a source device (not shown in the figure). In another example, the controlled switching device 120 may be part of another network device (not shown in the figure) such as a bay controller, protection device, breaker control unit, remote terminal unit, merging unit, process interface unit, and the like. The source device may be an Internet of things (IoT) device, a computing device, a personal computer, a laptop, a tablet, a mobile phone, and the like. In another example, the controlled switching device 120, may be hosted on a server (not shown in the figure) that may communicate with the source device. In one example, the controlled switching device 120 may receive signals, such as trip signals, auto-reclosing signals, fault information, circuit breaker closing commands, and the like, from devices that may be communicatively coupled to the controlled switching device 120. In another example, the controlled switching device 120 may detect the occurrence of a fault, issue trip signals, initiate auto-reclosing on the transmission line, and the like. For example, but not limited to, the controlled switching device 120 may include a protection and control unit (not shown in the figure). The protection and control unit may be configured to initiate the tripping of the first circuit breaker 112 and of the second circuit breaker 114, upon detection of a fault. In another example, the protection and control unit may be configured to initiate an auto-reclosure of the circuit breakers connected on the transmission line 102 to restore an isolated transmission line. In another example, the protection and control unit may be external to the controlled switching device 120 and may communicate with the controlled switching device 120 to initiate the auto-reclosing of the circuit breakers on the transmission line 102.

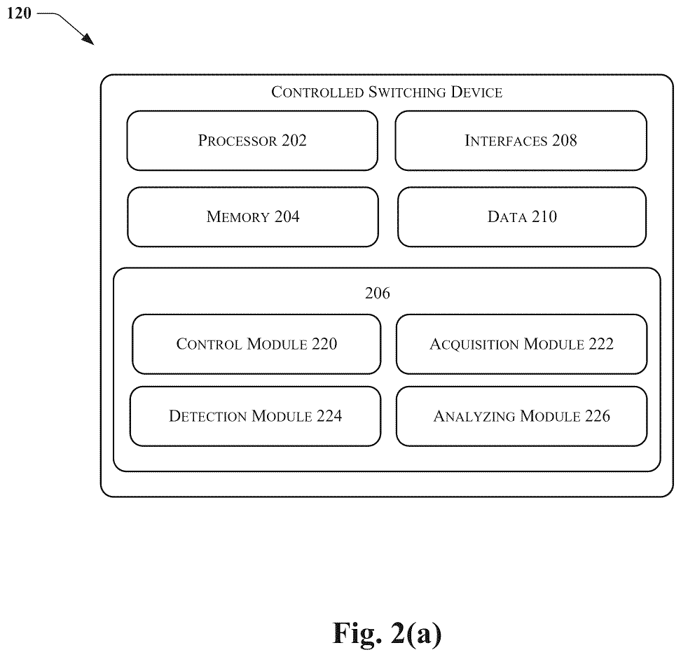

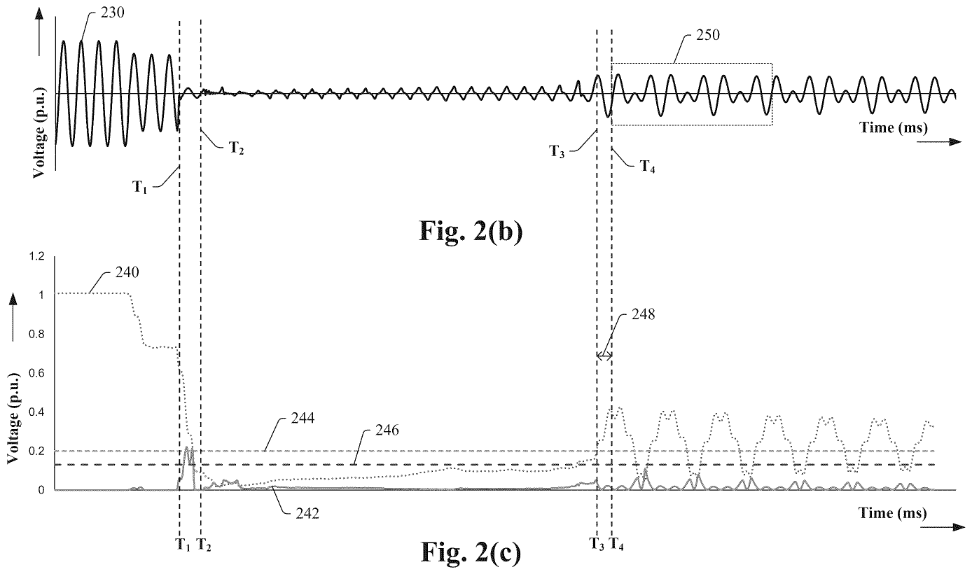

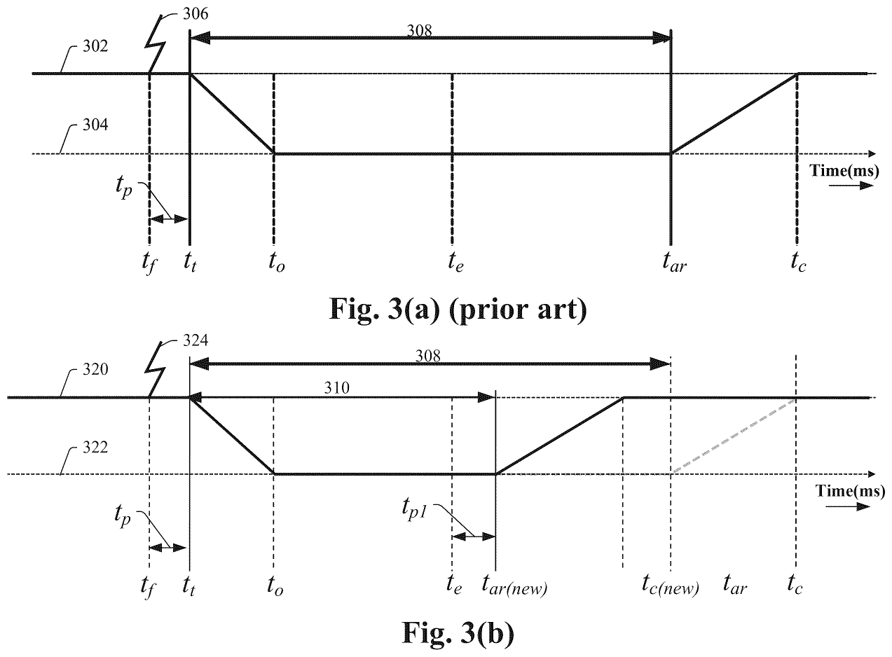

Further, the controlled switching device 120 may be configured to detect an extinction of a secondary arc occurring on the transmission line, and based on the detection of secondary arc extinction, the controlled switching device 120 may control auto-reclosing on the transmission line 102 by optimally determining a plurality of potential target auto-reclosure points, explained in detail with reference to FIG. 2(a)-2(c). In one example, the controlled switching device 120 may be configured to reduce a set dead time for auto-reclosing on the transmission line 102 based on the detection of secondary arc extinction, explained with reference to FIG. 3(b).

FIG. 2(a) illustrates a block diagram of a controlled switching device 120, in accordance with an embodiment of the present invention. In one example, the controlled switching device 120 may include a processor 202 and a memory 204 coupled to the processor 202. The functions of a functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. The memory 204 may include any computer-readable medium including, for example, volatile memory (e.g., RAM), and/or non-volatile memory (e.g., EPROM, flash memory, etc.).

In an example, the present invention may be implemented by one or more modules 206, alternatively and collectively referred to as modules 206. The modules 206 may be implemented as instructions executable by one or more processors. For instance, in the example where the controlled switching device 120 performs controlled auto-reclosure on the transmission line, the modules 206 are executed by the processors of the controlled switching device 120. In case the method is implemented in part by the controlled switching device 120 and in part by a server, the modules 206 (depending on the step) will be distributed accordingly in the controlled switching device 120 and the server. In one example, the one or more modules 206 may include a control module 220, an acquisition module 222, a detection module 224, an analyzing module 226, and the like.

In the present examples, the machine-readable storage medium may store instructions that, when executed by the processing resource, implement the functionalities of the modules 206. In such examples, the controlled switching device 120 may include the machine-readable storage medium storing the instructions and the processing resource to execute the instructions. In other examples of the present invention, the machine-readable storage medium may be located at a different location but accessible to the controlled switching device 120 and the processor 202.

In one example, the controlled switching device 120 may also include interfaces 208 which may include a variety of computer-readable instructions-based interfaces and hardware interfaces that allow interaction with other communication, storage, and computing devices, such as network entities, web servers, databases, and external repositories, and peripheral devices. In one example, interfaces 208 may be used to view the results obtained from the modules 206 and inputs received from the plurality of measurement devices (not shown in the figure), and the like. For example, the inputs obtained from the various measurement devices may be viewed on a graphical user interface like a display screen.

The controlled switching device 120 may further include data 210, that serves, amongst other things, as a repository for storing data that may be fetched, processed, received, or generated by the one or more modules 206. The data 210 may include communication data, user inputs, calibration parameters, voltage and current measurements, breaker status, fault currents, threshold values, and the like. In an example, the data 210 may be stored in the memory 204.

Further, the controlled switching device 120 is configured to perform controlled auto-reclosing on a transmission line 102. In one example, the detection module 224 of the controlled switching device 120 may detect a fault in any one of the phases of the transmission line 102. For example, but not limited to, the fault may be a single line to ground fault, in any one of the phases of the transmission line 102. Although the following description has been discussed with reference to isolation of the transmission line 102 with respect to a single line to ground fault, principles of the present invention are applicable to other scenarios, or faults, in one or more phases, where the transmission line may be isolated.

On detection of the fault, a trip signal may be issued to a first circuit breaker (not shown in the figure), or the local circuit breaker, and to the second circuit breaker (not shown in the figure), or the remote circuit breaker, in order to isolate the at least one phase of the transmission line from both ends. In one example, the trip signals may be issued by one or more protection devices external to the controlled switching device. In one example, the second circuit breaker may be tripped after a small duration of time, for example, a few milliseconds after the first circuit breaker is tripped. In one example, a status of the first circuit breaker and the second circuit breaker may be obtained by the controlled switching device 120. In another example, statuses of the circuit breakers may be obtained by any other devices and may be communicated to the controlled switching device 120. In an example, the statuses of the circuit breakers may be obtained individually for each pole of the respective circuit breaker.

After tripping of the local circuit breaker, the status of the local circuit breaker is generally detected as open and the current through the local circuit breaker is generally detected as zero or very low. However, the transmission line may still be energized through the remote circuit breaker. Therefore, the status of the local circuit breaker and/or the level of the current through the local circuit breaker alone, may be insufficient criteria for detecting de-energization or isolation of the transmission line. Although the following description has been discussed predominantly with respect to isolation of one phase of the transmission line, it may be understood that principles of the present invention are applicable to isolation of more than one phase of the transmission line, where similar principles of the invention as described below may be applied to each phase of the one or more isolated phases of the transmission line.

In an example, isolation of the transmission line may be detected by considering the statuses of both the local circuit breaker and the remote circuit breaker. In another example, isolation of the transmission line may be detected upon elapse of a preset time after the trip command to the local circuit breaker or after detecting opening of the local circuit breaker. In another example, isolation of the transmission line may be determined from a first waveform representing conditions on the transmission line, where the first waveform may be any one of a gap voltage waveform across the first circuit breaker, a transmission line voltage waveform, or a current waveform through a shunt reactor connected to the transmission line. The following description has been described by considering the first waveform to be a transmission line voltage waveform for ease of understanding. The detection of isolation of the transmission line, and further steps of detection of secondary arc extinction, sample collection, and analysis may be performed on the first waveform.

Further, in another example, isolation of the transmission line may be detected by an amplitude of the first waveform dropping below a set threshold, for example dropping below the set threshold. In another example, isolation of the transmission line may be detected by comparing a fundamental frequency component of the first waveform against a fundamental frequency threshold and comparing a harmonic frequency component of the first waveform against a harmonic frequency threshold, where, for example, line isolation may be detected when the fundamental frequency component is below the fundamental frequency threshold and the harmonic frequency component is above the harmonic frequency threshold. In another example, isolation of the transmission line may be detected when a difference between the frequency of a fundamental component and power frequency exceeds a set frequency threshold. In another example, isolation of the transmission line may be detected when a time difference between consecutive zero crossings of the first waveform exceed a set time threshold, for example, the set time threshold may be around 1 ms. In another example, isolation of the transmission line may be detected when a damping time constant determined from the first waveform is less than a damping constant threshold.

Upon isolation of the at least one phase of the transmission line, a secondary arc may occur. In one example, more than one phase of the transmission line may be isolated. For example, two phases of the three phases of the transmission line may be isolated and the following steps may be performed on each phase of the transmission line that is isolated. In one example, the generation of the secondary arc may be a result of the faulty phase being coupled to the healthy phases, which are still energized, of the transmission line through electrostatic and electromagnetic coupling. Due to mutual inductances between the two conductors, i.e., an isolated conductor of the faulty phase and an energized conductor of the healthy phase, voltage and current may be induced in the isolated conductor due to the current flowing in the energized conductor. As a result of this, a residual or secondary arc current continues to flow in the fault arc path. The generation of the secondary arc can be observed from FIG. 2(b).

FIG. 2(b) illustrates a graph depicting a transmission line voltage waveform 230, in accordance with an embodiment of the present invention. The transmission line voltage waveform 230 is represented as voltage along the y-axis and is plotted against time along the x-axis. In one example, to isolate the at least one phase of the transmission line, the contacts of the first circuit breaker and the second circuit breaker may be opened. In one example, at a time instant T₁, the first circuit breaker may be opened to isolate the fault from the first circuit breaker connected at the local end of the transmission line and at a time instant T₂, the second circuit breaker may be opened to isolate the transmission line from the second circuit breaker connected at the remote end of the transmission line. In one example, when the transmission line is isolated from both ends, i.e., the local end and the remote end, at the time instant T₂, a secondary arc may be generated. Generation of the secondary arc may be observed from the time instant T₂ to a time instant T₃. The time instant T₃ is an instant at which the secondary arc is extinguished. Presence of the secondary arc, among other parameters, may be characterized by an irregular waveform, which may be aperiodic in nature, containing rich harmonic content.

In one example, extinction of the secondary arc may be detected by comparing a fundamental frequency component and a harmonic frequency component of the transmission line voltage waveform upon isolation of the transmission line from both the local end and the remote end. On continuing the description of FIG. 2(a), in one example, to detect an extinction of the secondary arc, an acquisition module 222 of the controlled switching device 120 may acquire at least one signal corresponding to the first waveform, such as the transmission line voltage for example, on the at least one phase of the transmission line. On acquiring the transmission line voltage, a detection module 224 of the controlled switching device 120 may identify a fundamental frequency component and a harmonic frequency component of the at least one signal corresponding to the transmission line voltage on the at least one phase of the transmission line. As would be understood by a person skilled in the art, although the following description has been described with reference to detection of the secondary arc extinction based on a comparison of the fundamental frequency component and harmonic frequency component of the transmission line voltage waveform, principles of the present invention are applicable to other forms of detecting secondary arc extinction.

In one example, the fundamental frequency component and the harmonic frequency component may be analyzed to satisfy a pre-determined criterion. In one example, the pre-determined criterion may be that at least one of the fundamental frequency component may be above the fundamental frequency threshold and the harmonic frequency component may be below the harmonic frequency threshold. In one example, when the fundamental frequency component is above the fundamental frequency threshold and the harmonic frequency component is below the harmonic frequency threshold, for a preset amount of time, it may be identified that the secondary arc has been extinguished. In one example, the detection module 224 of the controlled switching device 120 may monitor the fundamental frequency component and the harmonic frequency component for the preset amount of time, to check if the pre-determined criteria is being satisfied to identify extinction of the secondary arc. In one example, the fundamental frequency threshold and the harmonic frequency threshold may be dependent on system parameters, such as type of line compensations, degree of compensation, line configuration, length of line, and the like.

FIG. 2(c) illustrates a graph depicting a fundamental frequency component 240 and a harmonic frequency component 242, in accordance with an embodiment of the present invention. The frequency components 240 and 242 are represented in per-unit bases along the y-axis and are plotted against time along the x-axis. At the time instant T₂, where the transmission line is isolated from the local end and the remote end, it may be observed that the fundamental frequency component 240 in transmission line voltage drops below the fundamental frequency threshold 244 whereas the harmonic frequency component 242 remains below the harmonic frequency threshold 246 due low magnitude oscillation of the secondary arc.

However, after some time, the fundamental frequency component 240 starts rising up and crosses the fundament frequency threshold 244. In one example, the rise in the fundamental frequency component 240 may depend on the residual voltage on the line. This status of the fundamental frequency component 240 and of the harmonic frequency component 242 may be monitored for a preset amount of time, for example, from a time instant T₃ to T₄. When the fundamental frequency component 240 continues to stay above the fundamental frequency threshold 244 and the harmonic frequency component 242 continues to stay below the harmonic frequency threshold 246 for the preset amount of time 248, then at the time instant T₄, it may be declared that the secondary arc has been quenched. Once the secondary arc is quenched, the transmission line voltage waveform 230 may tend to become more periodic in nature. From FIG. 2(b) and 2(c), it would be observed that after the time instant T₄, not only does the magnitude of the transmission line voltage increase, but also the fundamental frequency of the transmission line voltage waveform differs from nominal power frequency (as would be seen before isolation of the transmission line). Similarly, the fundamental frequency component 240 depicted in the FIG. 2(c), after the time instant T₄, may display properties of a periodic waveform.

Continuing with the description of FIG. 2(a), upon detection of extinction of the secondary arc, the analyzing module 226 of the controlled switching device 120 may collect a plurality of samples for a pre-determined time period. In one example, the plurality of samples may be collected after the time instant T₄. In one example, the pre-determined time period may be dynamically varied. In another example, the pre-determined time period may be based on a sampling window for a number of samples to be collected, as depicted by a sampling window 250 in FIG. 2(b). For example, the pre-determined time period may be set to a sampling window of 100 samples. In another example, the pre-determined time period may be dynamically varied based on one or more of a preset number of samples, parameters of the transmission line, method of signal analysis, or on a status of switchgear or control and protection devices in a substation in which the transmission line is connected.

On collecting a plurality of samples, the analyzing module 226 of the controlled switching device 120 may analyse the plurality of samples to identify parameters descriptive of the first waveform. Further, the plurality of samples may be extrapolated to form a second voltage waveform. In one example, the second voltage waveform may be extrapolated across the first circuit breaker based on the identified parameters. In one example, the identified parameters may refer to one or more of an oscillating frequency, a damping time constant, a DC offset, or a phase angle of one or more signal components determined from the first waveform using a Prony algorithm or a Matrix Pencil algorithm. In one example, the extrapolation of the samples collected may take a few milliseconds to generate the extrapolated second voltage waveform, alternatively referred to as an extrapolated waveform. Further, on extrapolating the second waveform across the first circuit breaker, a plurality of potential target auto-reclosure points may be determined. In one example, the plurality of potential target auto-reclosure points may be determined based on zero crossings of the extrapolated second voltage waveform across the first circuit breaker.

In one example, a target auto-reclosure instant may be dynamically selected from the plurality of potential target auto-reclosure points. In one example, to dynamically select the target auto-reclosure instant, the controlled switching device 120 may scan the plurality of potential target auto-reclosure points to identify a target auto-reclosure point that is reachable. The target auto-reclosure point that is reachable may be identified by considering a time delay that includes an expected internal delay time of the controlled switching device and a maximum expected closing time of the circuit breaker. In one example, the earliest reachable target auto-reclosure point may be identified at a point where the controlled switching device determines that the circuit breaker can be closed after considering all the possible delays that may occur, such as the expected internal delay time of the controlled switching device, the expected closing time of the circuit breaker, and the like. Further, by scanning all potential target auto-reclosure points later than the earliest target auto-reclosure point that is reachable, the target auto-reclosure instant may be selected, which would be the optimum target auto-reclosure instant.

In one example, the target auto-reclosure instant that is dynamically selected from the plurality of potential target auto-reclosure points may be based on properties of the first circuit breaker and of the potential target auto-reclosure points. For example, relevant properties of the circuit breaker may include one or more of a nominal closing time, statistical scatter of the closing time, nominal rate of decrease of dielectric strength (RDDS), statistical scatter of the RDDS, closing velocity, correction values based on evaluation of previous switching operations, and correction values based on external quantities that may affect the closing time, velocity, or RDDS. External quantities that may affect the closing time or RDDS of the circuit breaker may include, but not limited to, one or more of an ambient temperature, a drive temperature, a control voltage, an idle time since the last operation, a pressure or density of the insulating gas in the interrupter, a drive energy, a total time since installation or last overhaul, a total number of operations, and an accumulated interrupter wear. Further, in one example, relevant properties of the potential target auto-reclosure points may include, but not limited to, one or more of a time since tripping the circuit breaker or since isolation of the transmission line, a time since a command for tripping or for auto-reclosing of the circuit breaker, a time since start or completion of extrapolation of the second voltage waveform, a steepness of the second waveform in the vicinity of the potential target auto-reclosure point, a height of an extrapolated voltage peak in the second waveform preceding the potential target auto-reclosure point, a time difference between an extrapolated voltage peak in the second waveform and the potential target auto-reclosure point, and a time difference between potential target auto-reclosure points in different phases. For example, when more than one phase of a transmission line has been detected to be isolated, the properties of the potential target auto-reclosure points may include a time difference of the target auto-reclosure instants computed between each phase of the one or more phases of the transmission line.

Further, based on the target auto-reclosure instant that is dynamically selected, the control module 220 of the controlled switching device 120 may control a release of the first circuit breaker such that auto-reclosure of the first circuit breaker may be expected to occur at the target auto-reclosure instant. In particular, the control module may take into account the properties of the circuit breaker and of the dynamically selected target auto-reclosure instant in controlling release of the first circuit breaker. For example, the control module may determine an expected mechanical closing time and/or an electrical making time of the circuit breaker based on the properties of the circuit breaker and of the selected target auto-reclosure instant.

As the samples for extrapolating the second voltage waveform are collected only after detection of the secondary arc extinction, the extrapolated second voltage waveform matches an actual gap voltage waveform across the first circuit breaker. Therefore, by using the extrapolated second voltage waveform, the controlled switching device 120 may release a closing command, such that circuit breaker prestrike occurs near the gap voltage zero, which minimizes switching overvoltage on transmission line. In another example, the controlled switching device 120 may release a closing command, such that circuit breaker prestrike occurs near a gap voltage beat minimum. In another example, the controlled switching device 120 may release a closing command, such that circuit breaker prestrike may occur near a gap voltage zero located in a gap voltage beat minimum. Therefore, techniques of the present invention minimize the switching overvoltages on the transmission line.

Further, techniques of the present invention dynamically minimize the effective auto-reclosure dead time based on the detection of the secondary arc extinction on the transmission line. In one example, an auto-reclosure may be initiated on detection of the secondary arc extinction, explained with reference to FIG. 3(b). Minimizing the auto-reclosure dead time to shorter values than a set dead time results in quick restoration to service, while maintaining system stability, and minimizing the likelihood of reclosing onto a fault.

FIG. 3(a) illustrates a timing diagram of a trip and an auto-reclose event, considering a circuit breaker at one end of the transmission line based on techniques known in the art. As discussed above, an auto-reclosing dead time may be referred to the time between an issuance of a trip signal to a circuit breaker connected at a local end of the transmission line and initiation of auto-reclosure of the same circuit breaker for restoration of the transmission line. Typically, the auto-reclosing dead time is set during protection engineering, where typical values of auto-reclosing dead time vary between 700 milliseconds to 1000 milliseconds.

FIG. 3(a) shows a typical timing diagram of a trip and an auto-reclose event, considering only the circuit breaker at one line end, in accordance with techniques known in the art. The status of the circuit breaker plotted against time represented along the x-axis is shown. Signal 302 represents the contacts of the circuit breaker in a closed state and signal 304 represents the contacts of the circuit breaker in an open state. Initially, the contacts of the circuit breaker (not shown in the figure) remain closed. On inception of a fault 306 at a time instant t_{f}, the protection relay issues a trip signal to the circuit breaker at a time instant tₜ after a processing time tₚ. As the contacts of the circuit breaker open, it interrupts the current feeding the fault from the system. The instant at which the contacts of the circuit breaker open may be depicted as a time instant tₒ. However, a secondary arc may still be persistent, where the fault may still be fed through capacitive and inductive coupling from the healthy phases, which were not tripped and continue to be energized, or from energized parallel lines attached to the same towers. In a scenario where the conducting path to ground consists of ionized air, it may take additional time to recover and finally extinguish the secondary arc. In one example, a time instant where the secondary arc may be extinguished is denoted by tₑ. After the set auto-reclosure dead time 308, which includes a time period from issuance of the trip command to the instant at which the contacts of the circuit breaker open, the time required for fault clearance, and an additional amount of time to ensure that the auto-reclosure command is issued after the fault is extinguished, an auto-reclosing signal may be issued at a time instant tₐᵣ. The set auto-reclosing dead time 308 is often a compromise between quick restoration to service, system stability, and minimizing the likelihood of reclosing onto a fault still present. Longer auto-reclosing dead time decreases power quality to the consumers and increases the risk of system instability. Therefore, short auto-reclosing dead times are preferable. However, as protection and control systems known in the art do not detect if the fault has been completely extinguished before initiating auto-reclosure, short auto-reclosure dead times may come at an increased risk of reclosing onto a fault, which would aggravate the problems with power quality and system stability. As seen in FIG. 3(a), the set auto-reclosing dead time 308 is issued at the time instant tₐᵣ, after which, the contacts of the circuit breaker close at the time instant t_{c}. This creates an unnecessarily long waiting time between fault clearing at the time instant tₑ and circuit breaker reclosing at the time instant t_{c}.

FIG. 3(b) illustrates a timing diagram of a trip and an auto-reclose event, considering a circuit breaker at one end of the transmission line, in accordance with an embodiment of the present invention. In one example, the first circuit breaker connected to the local bus bar may be considered. In one example, the device (not shown in the figure) that initiates auto-reclosure of the circuit breaker, which may be a controlled switching device, a protection relay, or any other suitable electronic device, may dynamically minimize the set auto-reclosing dead time discussed above, based on the detection of secondary arc extinction on the transmission line. In one example, upon detection of the secondary arc extinction in all phases that had been tripped due to the fault, auto-reclosing of the circuit breaker may be initiated. In one example, detection of secondary arc extinction may be performed based on the techniques described with reference to FIG. 2(a)-2(c). In one example, but not limited to, if the set auto-reclosing dead time is set to 1100 ms and if the secondary arc extinction has been detected at 400 ms, then the auto-reclosing of the circuit breaker may be initiated at 600 ms instead of 1100 ms, therefore shortening the set auto-reclosing dead time significantly.

FIG. 3(b) represents a timing diagram in which the auto-reclosing dead time is significantly minimized. As depicted in FIG. 3(b), the status of the circuit breaker is plotted against time represented along the x-axis. Signal 320 represents the contacts of the circuit breaker in a closed state and signal 322 represents the contacts of the circuit breaker in an open state. Initially, the contacts of the circuit breaker (not shown in the figure) remain closed. On inception of a fault 324 at a time instant t_{f}, the protection relay may issue a trip signal to the circuit breaker at a time instant tₜ after a processing time tₚ. As the contacts of the circuit breaker open, the current feeding the fault from the system may be interrupted. The instant at which the contacts of the circuit breaker open may be depicted as a time instant tₒ. However, a secondary arc may still be persistent, where the fault may still be fed through capacitive and inductive coupling from the healthy phases, which were not tripped and continued to be energized, or from energized parallel lines attached to the same towers. In a scenario where the conducting path to ground consists of ionized air, it may take additional time to recover and finally extinguish the secondary arc. A time instant where the secondary arc may be extinguished is denoted by tₑ. Once the secondary arc is cleared at the time instant tₑ, the controlled switching device 120 may raise an indication that the secondary arc is quenched. For example, but not limited to, an indication in the form of a binary signal may be issued as soon as the secondary arc extinction is detected. In another example, in a scenario where the phase had no fault, and the contacts of the circuit breaker were open, a similar indication may be issued. Based on the indication, a reclosing of the circuit breaker may be initiated. In one example, the reclosing of the circuit breaker may be initiated after a short interval of time, represented as a processing time tₚₗ. The processing time tₚₗ may be representative of processing time utilized and delays caused by the device(s) and/or by the communication between the devices within the electrical network 100. In one example, the processing time may include, but not limited to, a waiting time for releasing the first circuit breaker such that auto-reclosure may occur at the selected target auto-reclosure instant, where the waiting time may include time taken for calculating the target auto reclosure instant while considering operating times of the circuit breakers, other internal delays, and the like, and the time required for transmitting information between the modules 206 within the controlled switching device 120. After the time interval tₚₗ, reclosing of the circuit breaker may be initiated at a time instant t_{ar(new)}. In one example, a combined indication of no secondary arc in all phases may be used as a condition for initiating auto-reclosing, even though the set auto-reclosing dead time 308 may not have expired.

In one example, the above-described method of shortening the auto-reclosure time may be implemented in a bay controller, a protection relay, or any other device that has access to the required primary signals. In one example, the controlled switching device may provide an option for a user to select from any one of initiating an auto-reclosure immediately after the detection of the secondary arc extinction, initiating an auto-reclosure based on the set auto-reclosing dead time 308, or inhibiting auto-reclosing based on additional information based on real-time analysis of the condition of the transmission line, for example, as the fault may be a permanent fault (e.g. a tree fallen onto the line).

Therefore, as can be observed from FIG. 3(a) and 3(b), the auto-reclosing of the circuit breaker may be initiated before the set auto-reclosing dead time 308 on detection of secondary arc extinction. Therefore, the time required to initiate auto-reclosing is minimized from the time period represented as 308 to a time period represented as 310, where the auto-reclosing would be initiated at the time instant t_{ar(new)} instead of tₐᵣ. Further, as the auto-reclosing time has been minimized, the contacts of the circuit breaker close at the time instant t_{c(new)} instead of the time instant t_{c}, thereby significantly reducing the auto-reclosing time. Thus, the power flow is restored far earlier than specified by the set auto-reclosing dead time when compared to techniques known in the art, which is beneficial to the electricity consumers and to the power system. Additionally, detection of extinction of the secondary arc minimizes the risk of reclosing onto a fault.

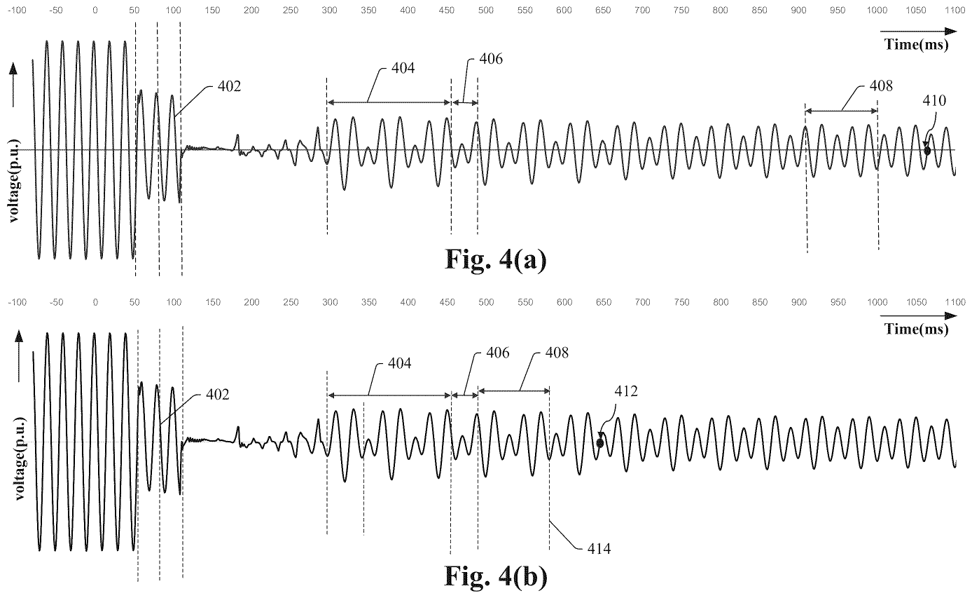

FIG. 4(a) illustrates an example controlled auto-reclosing on a transmission line, in accordance with an embodiment of the present invention. The present invention is now illustrated with the help of a working example, which is intended to illustrate the working of the present invention and not intended to be taken restrictively to imply any limitations on the scope of the present disclosure. Unless defined otherwise, all technical and scientific terms used herein have the same meaning as commonly understood to one of ordinary skill in the art to which this disclosure belongs. It is to be understood that this disclosure is not limited to the particular methods and experimental conditions described, as such methods and conditions may vary depending on the process and inputs used as will be easily understood by a person skilled in the art. FIG. 4(a) and 4(b) illustrate an example graph depicting optimized auto-reclosure.

From the graph of FIG. 4(a), signal 402 depicts a transmission line voltage waveform represented in per unit along the y-axis and plotted against time in milliseconds, along the x-axis. In one example, a fault may occur at about 60 ms, after which the transmission line voltage 402 may reduce to half its magnitude. In one example, the fault may be a single line to ground fault that occurs in at least one phase of the transmission line. On detection of the fault, the first circuit breaker connected to the local bus bar may be tripped at about 65 ms, which may then open at about 85 ms. On isolating the transmission line from the local bus bar end, at about 85 ms, the tripping of the second circuit breaker may be initiated at 90 ms, connected at a remote end of the transmission line. At about 110 ms, both the first circuit breaker and the second circuit breaker are opened, and the transmission line may be isolated from both the ends.

Further, a secondary arc may occur upon isolation of the transmission line from both the ends, as discussed above with reference to FIG. 2(a). The secondary arc generated may be observed in the graph of FIG. 4(a) during a time period from about 110 ms to about 300 ms. Presence of the secondary arc, among other parameters, may be characterized by an irregular waveform, which is aperiodic in nature, containing rich harmonic content. In one example, the controlled switching device (not shown in the figure) may be configured to detect an extinction of the secondary arc by identifying a fundamental frequency component and a harmonic frequency component of the transmission line voltage on the at least one phase of the transmission line as depicted in the FIG. 2(c). The fundamental frequency component and the harmonic frequency component are analyzed to satisfy a pre-determined criterion. In one example, the pre-determined criterion may be that at least one of the fundamental frequency component may be above a fundamental frequency threshold and the harmonic frequency component may be below a harmonic frequency threshold, and that the pre-determined criterion may be satisfied for a preset amount of time. Once the pre-determined criterion is satisfied, the device may raise an indication to indicate that the secondary arc has been quenched.

As it may be observed from the figure, once the secondary arc is quenched at about 300 ms, the transmission line voltage waveform 402 tends to become more periodic in nature. On extinction of the secondary arc, at about 300 ms, a plurality of samples may be collected to extrapolate a second voltage waveform. The plurality of samples may be collected for a pre-determined time period, for example, from about 300 ms to 450 ms, as indicated in the graph. In one example, the pre-determined time period 404 may be alternatively referred to as a sampling window. The sampling window may be increased or decreased based on the properties of the transmission line voltage signal. In another example, the pre-determined time period 404 may be based on a number of samples to be collected. For example, the pre-determined time period 404 may be set to a window of 150 samples or to a time frame of 150 ms. In another example, the pre-determined time period 404 may be dynamically varied based on any one of a preset number of samples, parameters of the transmission line, method of signal analysis, or on a status of switchgear or control and protection devices in a substation in which the transmission line is connected.

Upon collecting the plurality of samples, the controlled switching device 120 may be configured to analyse the samples in order to extrapolate them to form a second voltage waveform. In one example, analysis and extrapolation of the plurality of samples may take from about 450 ms to 500 ms, represented by the time period 406, to predict the second voltage waveform. At about 500 ms the device may provide an extrapolated second voltage waveform. Based on the extrapolated second voltage waveform provided at about 500 ms, the device may determine a plurality of potential target auto-reclosure points. The plurality of potential target auto-reclosure points may be determined based on zero crossings of the extrapolated second voltage waveform across the first circuit breaker.

In one example, a target auto-reclosure instant may be dynamically selected from the plurality of potential target auto-reclosure points based on properties of the first circuit breaker and of the potential target auto-reclosure points. To dynamically select the target auto-reclosure instant from the plurality of potential target auto-reclosure points, the controlled switching device, for example at 900 ms, may scan the plurality of potential target auto-reclosure points to identify a target auto-reclosure point that is reachable. The target auto-reclosure point that is reachable may be identified by considering a time delay 408 that includes an expected internal delay time of the controlled switching device and a maximum expected closing time of the circuit breaker. In one example, the earliest reachable target auto-reclosure point may be identified at 1000 ms. Further, by scanning all potential target auto-reclosure points later than the earliest target auto-reclosure point that is reachable which is identified at 1000 ms, the target auto-reclosure instant 410 is selected, for example, at about 1050 ms. Therefore, by using the extrapolated second voltage waveform, the device may release a closing signal, based on properties of the first circuit breaker and of the potential target auto-reclosure points, such that circuit breaker prestrike occurs near the target auto-reclosure instant 410. For example, the dynamically selected target auto-reclosure instant may be a gap voltage zero which minimizes switching overvoltages on the transmission line. In another example, the selected target auto-reclosure instant may be located in a gap voltage beat minimum. In another example, the selected target auto-reclosure instant may be a gap voltage zero located in a gap voltage beat minimum. In this example, the power flow may be restored about 1000 ms after fault inception.

Additionally, in one example, instead of initiating auto-reclosure after 900 ms as shown in FIG. 4(a), which may be a set auto-reclosing dead time of the first circuit breaker, the device may initiate auto-reclosure shortly after detection of the secondary arc extinction. For example, the device may indicate readiness for reclosing at about 500 ms as shown in FIG. 4(b), which may be the time when secondary arc extinction has been detected and extrapolation of the second voltage waveform is completed. FIG. 4(b) illustrates an example controlled auto-reclosing on a transmission line with shortened auto-reclosure time of a circuit breaker, in accordance with an embodiment of the present invention. Therefore, the earliest reachable target auto-reclosure point 414 that may be chosen from the plurality of potential target auto-reclosure points, may for example be around 600 ms, considering the expected internal delay time of the controlled switching device and the maximum expected closing time of the circuit breaker. Therefore, the control module in the controlled switching device may select a target auto-reclosure instant 412 from the plurality of potential target auto-reclosure points after the earliest reachable target auto-reclosure point 414, considering the properties of the circuit breaker and of the potential target auto-reclosure points. Thus, techniques of the present invention may dynamically minimize the auto-reclosure dead time based on the detection of the secondary arc extinction on the transmission line, thereby resulting in quick restoration to service, while maintaining system stability, minimizing switching transients, and minimizing the likelihood of reclosing onto a fault.

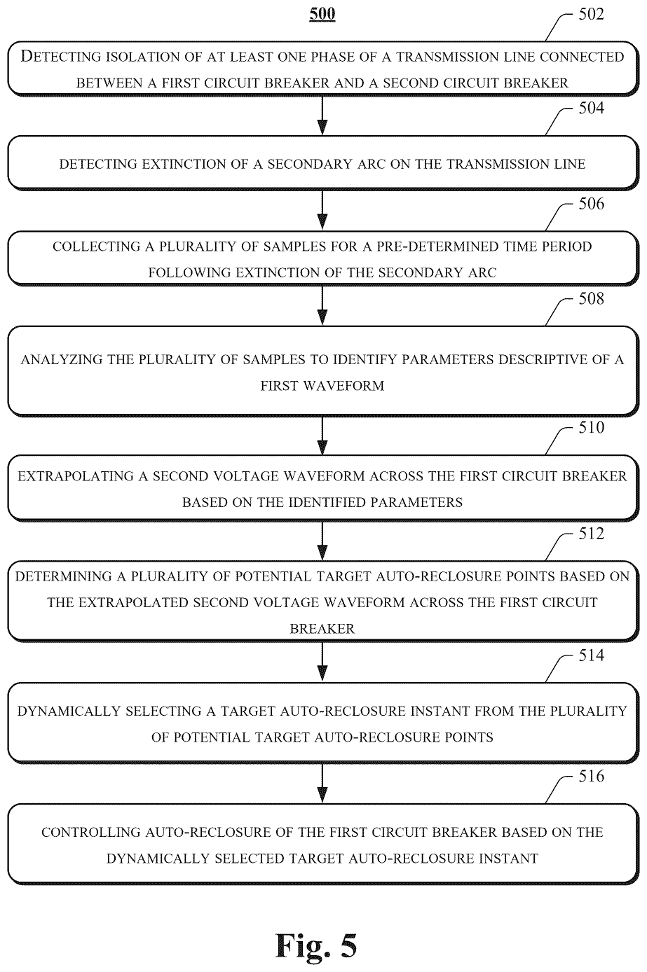

FIG. 5 illustrates a method for controlled auto-reclosure on a transmission line, in accordance with an embodiment of the present invention. The order in which method 500 is described is not intended to be construed as a limitation, and some of the described method blocks may be performed in a different order to implement the method 500 or an alternative method. Furthermore, the method 500 may be implemented in any suitable hardware, computer readable instructions, firmware, or combination thereof. For discussion, the method 500 is described with reference to the implementations illustrated in FIGS. 1-3 and 4(b).

In the method 500, at block 502, an isolation of at least one phase of a transmission line connected between a first circuit breaker and a second circuit breaker is detected. In one example, at least one phase of the transmission line may be isolated on detection of occurrence of a fault on the at least one phase of the transmission line. In another example, one or more phases of the transmission line may be isolated on detection of occurrence of a fault in the one or more phases.

In the method 500, at block 504, an extinction of a secondary arc on the transmission line is detected. In one example, the secondary arc may occur upon isolation of the at least one phase of the transmission line. In one example, detecting extinction of the secondary arc includes acquiring at least one signal corresponding to a first waveform on the at least one phase of the transmission line. In one example, the first waveform may be any one of a gap voltage waveform across the first circuit breaker, a transmission line voltage waveform, or a current waveform through a shunt reactor connected to the transmission line. Further, a fundamental frequency component and a harmonic frequency component of the at least one signal may be identified corresponding to the first waveform on the at least one phase of the transmission line, and the fundamental frequency component and the harmonic frequency component may be analyzed to satisfy a pre-determined criterion. In one example, the pre-determined criterion includes at least one of the fundamental frequency component being above a fundamental frequency threshold and the harmonic frequency component being below a harmonic frequency threshold. Further, detecting extinction of the secondary arc may include monitoring the fundamental frequency component and the harmonic frequency component to satisfy the pre-determined criterion for a preset amount of time.

In the method 500, at block 506, a plurality of samples are collected for a pre-determined time period following extinction of the secondary arc. In one example, the pre-determined time period may be dynamically varied based on one or more of a pre-determined number of samples, parameters of the transmission line, method of signal analysis, or on a status of switchgear or control and protection devices in a substation in which the transmission line is connected. In one example, the plurality of samples may be collected from any one of a gap voltage waveform across the first circuit breaker, a transmission line voltage waveform, or a current waveform through a shunt reactor connected to the transmission line.

In the method 500, at block 508, the plurality of samples are analyzed to identify parameters descriptive of the first waveform.

In the method 500, at block 510, a second voltage waveform across the first circuit breaker is extrapolated based on the identified parameters.

In the method 500, at block 512, a plurality of potential target auto-reclosure points are determined based on the extrapolated second voltage waveform across the first circuit breaker. In one example, the plurality of potential target auto-reclosure points are determined based on zero crossings of the extrapolated second voltage waveform across the first circuit breaker.

In the method 500, at block 514, a target auto-reclosure instant is dynamically selected from the plurality of potential target auto-reclosure points. In one example, the target auto-reclosure instant may be dynamically selected based on properties of the first circuit breaker and of the potential target auto-reclosure points. In one example, when more than one phase of a transmission line has been detected to be isolated, the properties of the potential target auto-reclosure points may include a time difference of the target auto-reclosure instants computed between each phase of the one or more phases of the transmission line.

In the method 500, at block 516, auto-reclosure of the first circuit breaker is controlled to occur at the dynamically selected target auto-reclosure instant. In one example, release of the first circuit breaker may be controlled such that auto-reclosure of the first circuit breaker is expected to occur at the target auto-reclosure instant, considering properties of the first circuit breaker and/or of the target auto-reclosure instant. In one example, the auto-reclosure of the first circuit breaker may be initiated before a set dead time of the first circuit breaker.

Therefore, techniques of the present invention minimize the switching overvoltages on the transmission line. Additionally, techniques of the present invention dynamically minimize the auto-reclosure dead time based on the detection of the secondary arc extinction on the transmission line, thereby resulting in quick restoration to service, while maintaining system stability, and minimizing the likelihood of reclosing onto a fault.

Although the present invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention.

1. A method comprising:
detecting isolation of at least one phase of a transmission line connected between a first circuit breaker and a second circuit breaker;
detecting extinction of a secondary arc on the transmission line;
collecting a plurality of samples for a pre-determined time period following extinction of the secondary arc;
analyzing the plurality of samples to identify parameters descriptive of a first waveform;
extrapolating a second voltage waveform across the first circuit breaker based on the identified parameters;
determining a plurality of potential target auto-reclosure points based on the extrapolated second voltage waveform across the first circuit breaker;
dynamically selecting a target auto-reclosure instant from the plurality of potential target auto-reclosure points; and
controlling auto-reclosure of the first circuit breaker based on the dynamically selected target auto-reclosure instant.

2. The method as claimed in claim 1, wherein dynamically selecting the target auto-reclosure instant is based on properties of the first circuit breaker and properties of the potential target auto-reclosure points.

3. The method as claimed in claim 2, wherein when more than one phase of a transmission line has been detected to be isolated, the properties of the potential target auto-reclosure points include a time difference of the target auto-reclosure instants computed between each phase of the one or more phases of the transmission line.

4. The method as claimed in claim 1, wherein auto-reclosure of the first circuit breaker is initiated before a set dead time of the first circuit breaker.

5. The method as claimed in claim 1, wherein the first waveform is any one of a gap voltage waveform across the first circuit breaker, a transmission line voltage waveform, or a current waveform through a shunt reactor connected to the transmission line.

6. The method as claimed in claim 1, wherein detecting extinction of the secondary arc comprises:
acquiring at least one signal corresponding to the first waveform in the at least one phase of the transmission line;
identifying a fundamental frequency component and a harmonic frequency component of the at least one signal corresponding to the first waveform in the at least one phase of the transmission line; and
analyzing the fundamental frequency component and the harmonic frequency component to satisfy a pre-determined criterion, wherein the pre-determined criterion comprises at least one of the fundamental frequency component being above a fundamental frequency threshold and the harmonic frequency component being below a harmonic frequency threshold.

7. The method as claimed in claim 6, wherein detecting extinction of the secondary arc comprises monitoring the fundamental frequency component and the harmonic frequency component to satisfy the pre-determined criterion for a preset amount of time.

8. The method as claimed in claim 1, wherein the plurality of potential target auto-reclosure points are determined based on zero crossings of the extrapolated second voltage waveform across the first circuit breaker.

9. The method as claimed in claim 1 comprising dynamically varying the pre-determined time period based on at least one of a pre-determined number of samples, parameters of the transmission line, method of signal analysis, or on a status of switchgear or of control and protection devices in a substation to which the transmission line is connected.

10. A controlled switching device comprising:
a detection module to
detect isolation of at least one phase of a transmission line connected between a first circuit breaker and a second circuit breaker; and
detect extinction of a secondary arc on the transmission line;
an analyzing module to
collect a plurality of samples for a pre-determined time period following extinction of the secondary arc;
analyze the plurality of samples to identify parameters descriptive of a first waveform;
extrapolate a second voltage waveform across the first circuit breaker based on the identified parameters;
determine a plurality of potential target auto-reclosure points based on the extrapolated second voltage waveform across the first circuit breaker; and
dynamically select a target auto-reclosure instant from the plurality of potential target auto-reclosure points; and
a control module to
control auto-reclosure of the first circuit breaker based on the dynamically selected target auto-reclosure instant.

11. The controlled switching device as claimed in claim 10, wherein dynamic selection of the target auto-reclosure instant is based on properties of the first circuit breaker and of the potential target auto-reclosure points.

12. The controlled switching device as claimed in claim 10, wherein auto-reclosure of the first circuit breaker is initiated before a set dead time of the first circuit breaker.

13. The controlled switching device as claimed in claim 10 comprising
an acquisition module to
acquire at least one signal corresponding to the first waveform in the at least one phase of the transmission line; and
wherein the detection module is to
identify a fundamental frequency component and a harmonic frequency component of the at least one signal corresponding to the first waveform in the at least one phase of the transmission line;
analyze the fundamental frequency component and the harmonic frequency component to satisfy a pre-determined criterion, wherein the pre-determined criterion comprises at least one of the fundamental frequency component being above a fundamental frequency threshold and the harmonic frequency component being below a harmonic frequency threshold; and
monitor the fundamental frequency component and the harmonic frequency component to satisfy the pre-determined criterion for a preset amount of time.

14. The controlled switching device as claimed in claim 10, wherein the plurality of potential target auto-reclosure points are determined based on zero crossings of the extrapolated second voltage waveform across the first circuit breaker.

15. A non-transitory computer readable medium comprising instructions that, when executed by a processor, cause the processor to execute the method of claim 1.
